(19) United States
(12) Patent Application Publication
(10) Pub. No.: US 2024/0066634 A1
(43) Pub. Date: Feb. 29, 2024

(54) LASER ENGRAVING MACHINE WITH THE ADJUSTMENT AND PROTECTION DEVICE

(71) Applicant: ASTEROID TRADING LIMITED, Hong Kong (HK)

(72) Inventor: Alexander Yebo Chen, Hong Kong (HK)

(21) Appl. No.: 17/975,534

(22) Filed: Oct. 27, 2022

(30) Foreign Application Priority Data
Aug. 26, 2022 (CN) 202222260305.9

(51) Int. Cl. B23K 26/364; B23K 26/06; B23K 26/067; B23K 26/08

(52) U.S. Cl. CPC B23K 26/364; B23K 26/0643; B23K 26/0665; B23K 26/067; B23K 26/0876

(57) ABSTRACT

The invention disclose a laser engraving machine with the adjustment and protection device, comprising the laser engraving machine frame, the CO₂ laser light source, the Y-axis guide rail, the X-axis guide rail; wherein the Y-axis guide rail and X-axis guide rail are provided fixedly on the laser engraving machine frame, the Y-axis guide rail and X-axis guide rail are provided in the vertical relationship, and the CO₂ laser light source is provided fixedly on the frame of the laser engraving machine; further comprising the combined beam and the first reflection combination device, the second reflection combination device, the beam splitting and engraving head assembly, and OR gate device; the combined beam and first reflection combination device is provided fixedly on the frame of the laser engraving machine.

### 1. TECHNICAL FIELD

The utility model relates to the technical field of laser engraving, in particular to a laser engraving machine with the adjustment and protection device.

### 2. BACKGROUND ART

As the light emitted from the carbon dioxide laser is invisible light, in the process of commissioning the optical path of the carbon dioxide laser engraving machine, it is necessary to open the laser frequently, by pointing the laser to double-sided tape and other non-metallic materials, through the spots formed by burning for the optical path debugging. Because the carbon dioxide laser is easy to cause partial combustion, easy to cause injury to the debugging personnel; debugging with double-sided tape and other paper, the burnt dust is easy to cause pollution to the reflecting lens; and the debugging process is very troublesome, with extremely high professional requirements of the debugging personnel. In the prior art, patent CN208178717U discloses a positive light path adjustment device, which needs to ensure that one end of the laser tube is equipped with a metal head, with the requirements of the metal head and the laser tube coaxial, greatly increasing the production cost of the laser tube.

Traditional CO₂ laser engraving machine, in order to protect people from the damage of 10.6 um infrared laser, usually at the top cover of the CO₂ engraving machine plus Hall switch or proximity switch, and once the top cover is opened, then cut off the laser power and shut down the laser to avoid injury. The actual process in use, due to the need to watch the details or internal point and shoot for dimming, commissioning personnel will often use magnets and other special operations, so that the 10.6 um infrared laser can be still emitted when opening the top cover of the CO₂ engraving machine. In this case, if the fingers or arms of the commissioning personnel or bystanders accidentally reach into the optical path, they may be damaged by the 10.6 um infrared laser.

Traditional CO₂ laser engraving machine, in order to indicate the infrared laser engraving and cutting path, is usually fixed with the fixed a red laser near the engraving head, and after the artificial focus of the infrared laser, the red laser beam is tuned to 10.6 um infrared laser spot. The disadvantage of the method is that once the work surface deviates from the focus of the infrared laser, then the position of the indicator light is also deviated, resulting in the failure of accurately reflecting the infrared laser spot position.

To solve the current technical problems, the utility model provides laser engraving machine with the adjustment and protection device, cleverly using the coaxiality of the CO₂ laser beam and the visible light beam emitted by the photoelectric switch light source, realizing the visualization of the invisible infrared laser adjustment process, and at the same time protecting people or objects from being burned by accidentally reaching into the infrared light path, and further realizing the visualization of the invisible infrared laser engraving and cutting path.

### 3. SUMMARY OF THE INVENTION

To achieve the above objects and based on the above background, the utility model provides a laser engraving machine with the adjustment and protection device.

To solve the above technical problems in the background, the technical solutions provided by the utility model are as follows:

A laser engraving machine with the adjustment and protection device, comprising the laser engraving machine frame, the CO₂ laser light source, the Y-axis guide rail, the X-axis guide rail; wherein the Y-axis guide rail and X-axis guide rail are provided fixedly on the laser engraving machine frame, the Y-axis guide rail and X-axis guide rail are provided in the vertical relationship, and the CO₂ laser light source is provided fixedly on the frame of the laser engraving machine; wherein further comprising the combined beam and the first reflection combination device, the second reflection combination device, the beam splitting and engraving head assembly, and OR gate device; the combined beam and first reflection combination device is provided fixedly on the frame of the laser engraving machine, the second reflection combination device is provided on the Y-axis guide rail, the beam splitting and engraving head assembly is provided on the X-axis guide rail; the combined beam and first reflection combination device is provided in front of the CO₂ laser light source beam in the direction of travel, the second combination reflection device is provided in front of the CO₂ laser light source beam reflected by the combined beam and first reflection combination device in the direction of travel, and the beam splitting and engraving head assembly is provided in front of the CO₂ laser light source beam reflected by the second reflection combination device in the direction of travel; and the OR gate device is electrically connected to the beam splitting and engraving head assembly.

Further, the combined beam and first reflection combination device comprises the beam combining device, the first reflecting mirror assembly, and the assembly support; the first reflecting mirror assembly is provided in front of the beam traveling direction of the beam combining device, the beam combining device and the first reflecting mirror assembly are provided on the assembly support.

Further, the beam combining device comprises beam combining device frame, visible light source, beam combining lens, visible light source fixing plate, reduction screws with spring, adjusting screws; the beam combining lens and visible light source fixing plate are provided fixedly on the beam combining device frame, the visible light source, reduction screws with spring, the adjusting screws are provided fixedly on the visible light source fixing plate.

Further, the surface of the beam combining lens has a high reflection function for the beam emitted from the visible light source with the reflection rate of ≥90% and a high transmission function for the beam emitted from the CO₂ laser light source with the transmission rate of ≥95%.

Further, the surface of the beam combining lens has a high reflection function with 650 nm laser and the reflectivity of ≥90%, and with 10.6 um laser high transmission function and the transmittance of ≥95%.

Further, the wavelength of the visible light source is from 400 nm to 760 nm.

Further, the visible light source is the red-light laser with 650 nm.

Further, the beam splitting and engraving head assembly comprises the beam splitting device and the laser engraving head assembly; the laser engraving head assembly is provided in front of the travel direction of the beam emitted by the CO₂ laser light source 1 reflected by the beam splitting device.

Further, beam splitting device comprises photoelectric receiver, beam splitting mirror, photoelectric receiver fixing plate and beam splitting mirror holder; the photoelectric receiver is provided fixedly on the laser engraving head assembly by the photoelectric receiver fixing plate; the beam splitting mirror is provided fixedly on the laser engraving head assembly by the beam splitting mirror holder, and the laser engraving head assembly comprises the third reflecting mirror and the focusing lens.

Further, the beam splitting mirror is low reflective at the beam from the visible light source, with the reflectivity of 10% to 50%, and high transmissive at the beam from the CO₂ laser light source, with the transmittance of ≥95%.

Compared to the prior arts, the utility model has the following advantages and beneficial effects:
1. The laser engraving machine provided by the utility model enables quick adjustment of the second and third mirrors.
2. The laser engraving machine provided by the utility model provides a safer commissioning and use process.
3. The laser engraving machine provided by the utility model further realizes visualization of the engraving and cutting paths.

### 4. BRIEF DESCRIPTION OF ACCOMPANY DRAWINGS

FIG. 1 is a schematic diagram showing the optical path and structure of the industry-common laser engraving machine;

FIG. 2 is a schematic diagram showing the optical path and structure of the laser engraving machine provided by the utility model;

FIG. 3 is a schematic diagram showing the beam combining device provided by the utility model;

FIG. 4 is a schematic diagram showing the light splitting device provided by the utility model;

FIG. 5 is a schematic diagram showing OR gate device provided by the utility model;

FIG. 6 is a schematic diagram showing the structure of the front side of the laser engraving machine with adjustment and protection device provided by the utility model inclined down to the left;

FIG. 7 is a schematic diagram showing the structure of the front side of the laser engraving machine with adjustment and protection device provided by the utility model inclined down to the right.

Wherein: 1. the CO₂ laser light source; 2. the combined beam and first reflection combination device; 21. the combined beam device; 211. the visible light source; 212. the beam combining mirror; 213. the fixing plate; 214. the reduction screws with spring; 215. the adjustment screws; 22. the first reflecting mirror assembly; 221. the first reflecting mirror; 23. the assembly support; 3. the second reflection combination device; 31. the second reflecting mirror; 4, the beam splitting and engraving head assembly; 41. the beam splitting device; 411. the photoelectric receiver; 412. the beam splitting mirror; 413. the photoelectric receiver fixing plate; 414. the beam splitting mirror holder; 42. the laser engraving head assembly; 421, the third reflecting mirror; 422. the focusing lens; 5, the OR gate device; 6, the laser power supply; 7. the Y-axis guide rail; 8. the X-axis guide rail; 9. the laser engraving machine frame.

### 5. SPECIFIC EMBODIMENT OF THE INVENTION

To make the purpose, technical solutions and advantages of the embodiments provided by the invention more comprehensible, a further description of the invention is given below in combination with the attached drawings and embodiments.

A further description of the invention is given below in combination with the attached drawings and embodiments.

### Embodiment 1

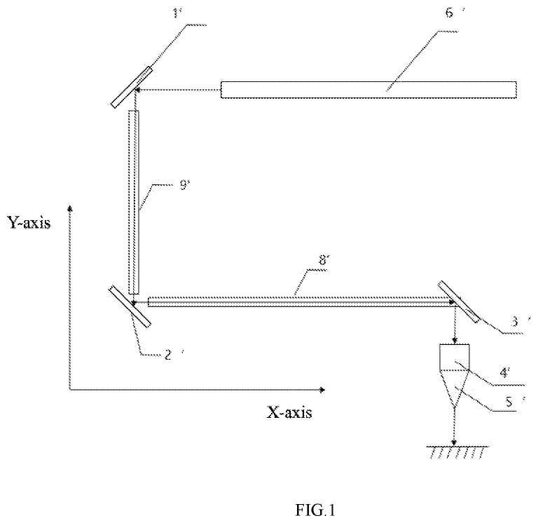

As shown in the FIG. 1, the optical system of the existing design of the usual CO₂ laser engraving machine comprises: the light source 6′, the first reflecting mirror 1′, the second reflecting mirror 2′, the third reflecting mirror 3′, mirror holder 4′, focusing lens component 5′. The functions of each component and assembly are as follows: light source 6′ is the CO₂ laser light source that provides light energy for engraving, the first reflecting mirror 1′ converts the light path from X-axis direction to Y-axis direction, the second reflecting mirror 2′ converts the light path from Y-axis direction to X-axis direction; while the second reflecting mirror 2′ moves along the Y-axis guide 9′ to realize the laser scanning in the Y′ axis direction, and the third reflecting mirror 3′ converts the light path from the XY plane to the Z-axis direction (Z-axis is the axis perpendicular to the plane composed of X-axis and Y-axis), while the third reflecting 3′ moves along the X-axis guide rail 8′, enabling the laser to scan in the X′ axis direction; and the mirror holder 4′ is a structural member connecting the third reflecting mirror 3′ and the focusing lens assembly 5′; the focusing lens assembly 5′ is to focus the laser to make the energy more concentrated when engraving. The beam travel schematic diagram is shown in FIG. 1, where with the X-axis and Y-axis in the same plane, and the laser in the third reflecting mirror 3′ after the reflection of the direction becomes perpendicular to the X-axis and Y-axis is located in the plane down, and the attached figure is reflected in a grounded manner.

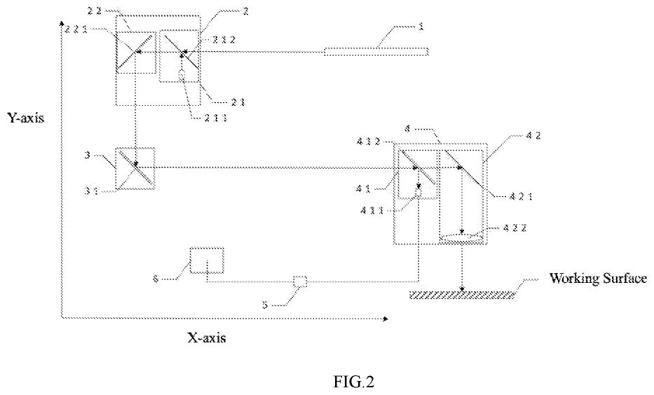

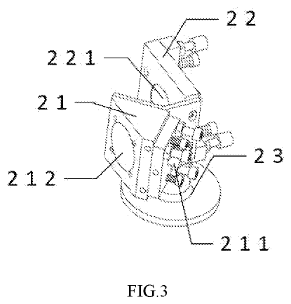

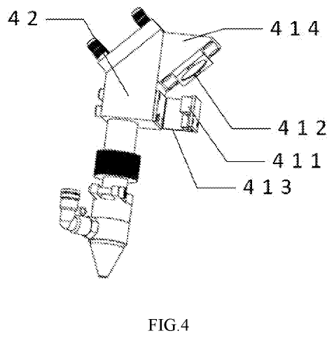

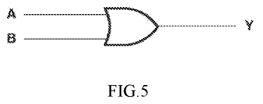

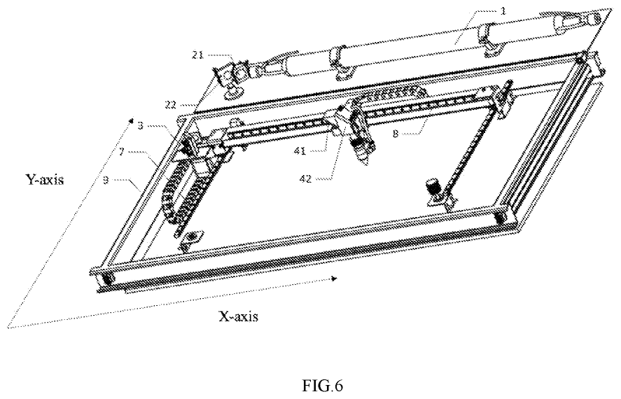

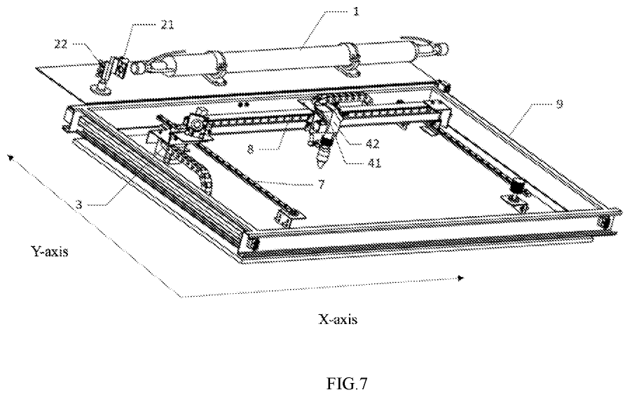

Referring to FIG. 2-7, the utility model designs a laser engraving machine with adjustment and protection device. A laser engraving machine with adjustment and protection device, comprising a laser engraving machine frame 9, the CO₂ laser light source 1, the combined beam and the first reflection combination device 2, the second reflection combination device 3, the Y-axis guide rail 7, the beam splitting and engraving head assembly 4, the X-axis guide rail 8 and OR gate device 5; wherein the combined beam and first reflection combination device 2 and the CO₂ laser light source 1 are provided fixedly on the frame 9 of the laser engraving machine, and the combined beam and first reflection combination device 2 is provided in front of the CO₂ laser light source 1 beam in the direction of travel; the Y-axis guide rail 7 and X-axis guide rail 8 are provided fixedly on the laser engraving machine frame 9, the Y-axis guide rail 7 and X-axis guide 8 rail are provided in the vertical relationship, and the Y-axis guide rail 7 is on the same side of the CO₂ laser source 1 as the X-axis guide rail 8; the second reflection combination device 3 is provided on the Y-axis guide rail, the beam splitting and engraving head assembly 4 is provided on the X-axis guide rail; the second reflection combination device 3 and the beam splitting and engraving head assembly 4 can be moved along the Y-axis and X-axis respectively, to achieve engraving and cutting functions; the second combination reflection device is provided in front of the CO₂ laser light source beam reflected by the combined beam and first reflection combination device in the direction of travel, and the beam splitting and engraving head assembly is provided in front of the CO₂ laser light source beam reflected by the second reflection combination device in the direction of travel; the CO₂ laser light source 1 is provided preferably with a 10.6 um infrared laser light source.

The combined beam and first reflection combination device 2 comprises the beam combining device 21, the first reflecting mirror assembly 22, and the assembly support 23; the first reflecting mirror assembly 22 is provided in front of the beam traveling direction of the CO₂ laser light source 1 of the beam combining device 21, the beam combining device 21 and the first reflecting mirror assembly 22 are provided on the assembly support 23.

The beam combining device 21 comprises beam combining device frame, visible light source 211, beam combining lens 212, visible light source fixing plate 213, reduction screws with spring 214, adjusting screws 215; the beam combining lens 212 and visible light source fixing plate 213 are provided fixedly on the beam combining device frame, the visible light source 211, reduction screws with spring 214, the adjusting screws 215 are provided fixedly on the visible light source fixing plate 213. The beam combining device 21 is driven by rotating the three adjustment screws 215 to shift the visible light source fixing plate 213 in pitch, as the visible light source 211 is fixed directly on the visible light source fixing plate 213, to rotate the three adjusting screws and to realize the adjustment of the beam of the visible light source 212 in pitch; the beam combining lens 212 is capable of combining the visible beam emitted by the visible light source 211 with the beam emitted by the CO₂ laser light source 1, which requires in particular that the surface of the beam combining lens 212 has a visible light high reflection function, preferably with the reflectivity of ≥90%, and a high transmission function, preferably with the transmittance of ≥95%; more preferably, the beam combining lens 212 is capable of combining a 650 nm laser beam with a 10.6 um CO₂ laser beam, which requires in particular that the surface of the beam combining lens 212 is highly reflective of the 650 nm laser, preferably with the reflectivity of ≥90%, and highly transmissive of the 10.6 um laser, preferably with the transmittance of ≥95%; the visible light source 211 wavelength can be selected from 400 nm to 760 nm visible light source, preferably the 650 nm red light laser.

The beam combining device 21 can be realized the adjustment in pitch, and the adjustment for coaxial beam combining requires turning on both the CO₂ laser light source 1 and the visible light source 211, and then placing the corresponding light-sensitive paper in front of the first reflecting paper or the second reflecting paper or the third reflecting paper or the laser engraving point; and realize the adjustment in pitch through the visible light source fixing plate 213, when the light-sensitive point coincides with the visible light, then the visible beam from the visible light source 211 is adjusted to be coaxial with the beam from the CO₂ laser light source 1.

The first reflecting mirror assembly 22 comprises the first reflecting mirror 221 and the first reflecting mirror holder, and the first reflecting mirror 221 is provided fixedly on the first reflecting mirror holder. The second reflection combination assembly 3 comprises the second reflecting mirror 31 and the second reflecting mirror holder, and the second reflection combination assembly 3 is provided in front of the combined beam and first reflection combination assembly 2 in the direction of beam travel.

The beam splitting and engraving head assembly 4 comprises the beam splitting device 41 and the laser engraving head assembly 42; the laser engraving head assembly 42 is provided in front of the travel direction of the beam emitted by the CO₂ laser light source 1 reflected by the beam splitting device 41.

The beam splitting device 41 comprises photoelectric receiver 411, beam splitting mirror 412, photoelectric receiver fixing plate 413 and beam splitting mirror holder 414; the photoelectric receiver 411 is provided fixedly on the laser engraving head assembly 42 by the photoelectric receiver fixing plate 413; the beam splitting mirror 412 is provided fixedly on the laser engraving head assembly 42 by the beam splitting mirror holder 414.

The laser engraving head assembly 42 comprises the third reflecting mirror 421 and the focusing lens 422.

After the combined beam from the CO₂ laser source 1 and the visible light source 211 passes through the beam splitting mirror 412, and more than 99% of the beam from the CO₂ laser source 1 and part of the beam from the visible light source 211 passes through the beam splitting mirror 412 and continues to be transmitted to the third reflecting mirror 421, and part of the beam from the visible light source 211 passes through the beam splitting mirror 412 and is reflected on the photoelectric receiver 411.

The beam splitting mirror 412 allows a portion of the visible beam to reach the photoelectric receiver 411, which in particular requires low reflection at visible light with the reflectivity of 10% to 50%, high transmission of the CO₂ laser beam with the transmittance of ≥95%; more preferably, the beam splitting mirror 412 allows a portion of the 650 nm laser beam to reach the photoelectric receiver 411, which in particular requires low reflection at 650 nm with the reflectivity of 10% to 50%, high transmission of 10.6 um with the transmittance ≥95%.

The OR gate device 5 is connected to the beam splitting and engraving head assembly 4, specifically to the photoelectric receiver 411 and the connection is a direct or indirect electrical connection. Wherein the OR gate device 5 has signal inputs at the A and B inputs, and after processing, outputting the processed signal at the output Y. In particular, if one of the inputs A and B is a high-level signal, then the output Y obtains a high-level signal. If there is an obstacle blocking in the light path, the photoelectric receiver 411 cannot detect the light signal, and then the photoelectric receiver output high level signal, and through the OR gate device 5, the high level signal was transmitted to the laser power supply 6; the laser power supply 6 will automatically disconnect after obtaining the high level signal; because of the relatively larger receiving area of the photoelectric receiver 411, the photoelectric receiver 411 in the photoelectric receiver fixing plate and the photoelectric receiver 411 is adjustable on the photoelectric receiver fixing plate 413, so that the beam splitting device 41 can be adjusted without pitch.

As shown in FIG. 1, the operation principle of the laser engraving machine with regulation and protection device provided by utility model for regulation and protection is as follows:

The beam combining device 21 combines the 10.6 um beam from the CO₂ laser light source 1 and the 650 nm beam from the visible light source 211; and after combining the beams, adjusting the first reflecting mirror 221, the second reflecting mirror 31, and the third reflecting mirror 421, the 650 nm visible beam can be used for adjustment to ensure that the combined beam is located in the center of the reflecting mirror; and at the same time ensuring that the incident beam and the outgoing beam are perpendicular, thus the adjustment of the first reflecting mirror 221, the second reflecting mirror 31, the third reflecting mirror 421 can be considered to meet the requirements; because of the coaxiality of the combined beam, the visible light trajectory seen by the naked eye is also the CO₂ laser light source 1 infrared light trajectory, thus enables the convenient adjustment of the laser engraving machine.

When the 650 nm visible light beam from the visible light source 211 and the 10.6 um infrared laser beam from the CO₂ laser source 1 pass through the beam combining device 21, the two beams become a coaxial combined beam by adjusting the beam combining mirror holder 22; and the beam combining mirror device 21 is next to the CO₂ laser 1; and since the laser engraving head assembly 42 and the beam splitting mirror holder 414 are connected together, the beam from the beam combining device 21 to the beam splitting mirror 412 contains the combined beams of 10.6 um and 650 nm.

When the debugging personnel's hand or an obstacle is inserted into the optical path, which blocks the 650 nm beam, the photoelectric receiver 33 detects that the 650 nm beam is blocked and immediately sends out a high level signal to control the laser power supply 6 through the OR gate device 5, which immediately turns off the 10.6 um laser emitted by the CO₂ laser source 1 to avoid the debugging personnel's hand or obstacle being burned by the 10.6 um infrared laser, playing a role in the protection of people or obstacles.

The combined beam of the 10.6 um infrared beam transmitted by the beam splitting mirror 412 and part of the 650 nm beam passes through the third reflecting mirror 421 and the focusing lens 422 of the laser engraving head assembly 42, and then the combined beam converges to the engraved or cut work surface, where the 650 nm spot and the 10.6 um infrared laser on the work surface are located at the same point. Due to the visualization of the 650 nm spot, it is possible to indirectly respond to the visualization of the engraving and cutting path of the 10.6 um infrared laser, and the focal position of the two beams coincides exactly, providing the precise positioning.

In conclusion, the utility model overcomes the problems in the prior art and provides a laser engraving machine with the adjustment and protection device, which enables quick adjustment of the second and third mirrors of the CO₂ engraving machine, providing a safer commissioning and use process and further realizing visualization of the engraving and cutting paths.

The invention and the embodiments thereof are described hereinabove, and this description is not restrictive. What is shown in the drawing is only the principles and one of the preferred embodiments of the invention, and the actual structure is not limited thereto. In summary, any equivalent structures or equivalent process transformations made by using the specifications and the attaching drawings of the invention, or direct or indirect applications to other related technical fields, shall all fall within the protection scope of the invention.

1. A laser engraving machine with the adjustment and protection device, comprising the laser engraving machine frame, the CO₂ laser light source, the Y-axis guide rail, the X-axis guide rail; wherein the Y-axis guide rail and X-axis guide rail are provided fixedly on the laser engraving machine frame, the Y-axis guide rail and X-axis guide rail are provided in the vertical relationship, and the CO₂ laser light source is provided fixedly on the frame of the laser engraving machine; wherein further comprising the combined beam and the first reflection combination device, the second reflection combination device, the beam splitting and engraving head assembly, and OR gate device; the combined beam and first reflection combination device is provided fixedly on the frame of the laser engraving machine, the second reflection combination device is provided on the Y-axis guide rail, the beam splitting and engraving head assembly is provided on the X-axis guide rail; the combined beam and first reflection combination device is provided in front of the CO₂ laser light source beam in the direction of travel, the second combination reflection device is provided in front of the CO₂ laser light source beam reflected by the combined beam and first reflection combination device in the direction of travel, and the beam splitting and engraving head assembly is provided in front of the CO₂ laser light source beam reflected by the second reflection combination device in the direction of travel; and the OR gate device is electrically connected to the beam splitting and engraving head assembly.

2. A laser engraving machine with the adjustment and protection device according to the claim 1, wherein the combined beam and first reflection combination device comprises the beam combining device, the first reflecting mirror assembly, and the assembly support; the first reflecting mirror assembly is provided in front of the beam traveling direction of the beam combining device, the beam combining device and the first reflecting mirror assembly are provided on the assembly support.

3. A laser engraving machine with the adjustment and protection device according to the claim 2, wherein the beam combining device comprises beam combining device frame, visible light source, beam combining lens, visible light source fixing plate, reduction screws with spring, adjusting screws; the beam combining lens and visible light source fixing plate are provided fixedly on the beam combining device frame, the visible light source, reduction screws with spring, the adjusting screws are provided fixedly on the visible light source fixing plate.

4. A laser engraving machine with the adjustment and protection device according to the claim 3, wherein the surface of the beam combining lens has a high reflection function for the beam emitted from the visible light source with the reflection rate of ≥90% and a high transmission function for the beam emitted from the CO₂ laser light source with the transmission rate of ≥95%.

5. A laser engraving machine with the adjustment and protection device according to the claim 3, wherein the surface of the beam combining lens has a high reflection function with 650 nm laser and the reflectivity of ≥90%, and with 10.6 um laser high transmission function and the transmittance of ≥95%.

6. A laser engraving machine with the adjustment and protection device according to the claim 3, wherein the wavelength of the visible light source is from 400 nm to 760 nm.

7. A laser engraving machine with the adjustment and protection device according to the claim 3, the visible light source is the red-light laser with 650 nm.

8. A laser engraving machine with the adjustment and protection device according to the claim 1, wherein the beam splitting and engraving head assembly comprises the beam splitting device and the laser engraving head assembly; the laser engraving head assembly is provided in front of the travel direction of the beam emitted by the CO₂ laser light source 1 reflected by the beam splitting device.

9. A laser engraving machine with the adjustment and protection device according to the claim 8, wherein beam splitting device comprises photoelectric receiver, beam splitting mirror, photoelectric receiver fixing plate and beam splitting mirror holder; the photoelectric receiver is provided fixedly on the laser engraving head assembly by the photoelectric receiver fixing plate; the beam splitting mirror is provided fixedly on the laser engraving head assembly by the beam splitting mirror holder, and the laser engraving head assembly comprises the third reflecting mirror and the focusing lens.

10. A laser engraving machine with the adjustment and protection device according to the claim 9, wherein the beam splitting mirror is low reflective at the beam from the visible light source, with the reflectivity of 10% to 50%, and high transmissive at the beam from the CO₂ laser light source, with the transmittance of ≥95%.
